(19) United States
(12) Patent Application Publication
(10) Pub. No.: US 2025/0158373 A1
(43) Pub. Date: May 15, 2025

(54) Five-phase overhead power line

(71) Applicant: Terna S.p.A., Roma RM (IT)

(72) Inventors: Roberto SPEZIE, Roma RM (IT); Francesco PALONE, Roma RM (IT); Luciano ZUCCOLO, Roma RM (IT); Maria Rosaria GUARNIERE, Roma RM (IT)

(21) Appl. No.: 18/860,919

(22) PCT Filed: Feb. 6, 2023
(86) PCT No.: PCT/IB2023/051037

§ 371 Date: Oct. 28, 2024

(30) Foreign Application Priority Data
May 2, 2022 (IT) 102022000008843

(51) Int. Cl. H02G 7/00

(52) U.S. Cl. CPC H02G 7/00

(57) ABSTRACT

An overhead power line, in particular for medium and high voltage, comprising a five-phase power line, for a given number of conductors, and a plurality of pylons. Each of the pylons comprises a head portion to which the five electrical phases are fixed by means of their respective five attachment points, and a ground support portion fixed to the head portion. The five attachment points comprise four external attachment points arranged at the vertices of a quadrilateral and vertically misaligned with each other, and one internal attachment point arranged within the quadrilateral and vertically misaligned with the external attachment points. Each of the attachment points is of the suspension type supported by a pair of insulator chains arranged in a “V” or “L” shape and fixed to the head portion.

### TECHNICAL FIELD OF THE INVENTION

The present invention relates to a five-phase overhead power line, particularly for medium and high voltage.

### BACKGROUND

As known, the power supply of electrical utilities typically takes place via a low-voltage (between 50 and 1,000 V), medium-voltage (between 1,000 V and 35,000 V), and high-voltage (for voltages higher than 35,000 V) electric power distribution network.

Distribution networks are in turn connected to the electric power transmission network, which, operating over long distances, operates at high-(greater than 35,000 V and up to 230,000 V) and extra-high voltage (greater than 230,000 V).

The overhead power line is the network infrastructure intended for both the distribution and transmission of electric power by means of a plurality of conductors supported by a plurality of pylons.

The anthropic development of the territory has often made overhead power lines, almost always pre-existing, closely affected by the presence of new infrastructure and civil dwellings. As a consequence, there is the potential risk of limiting the amperometric capacity, due to problems of exposure to the magnetic fields produced by the power lines, as well as disputes with the territory.

As may be apparent to a person skilled in the art, this potential risk of limiting the current amperometric capacity of conductors constitutes an important limitation to the distribution and/or transmission of power energy.

According to the laws of physics, an increase in the power line electric current typically corresponds to a greater magnetic field produced by them, thus a greater boundary volume subtended and, therefore, considering the projection of the aforesaid volume on the ground, a greater “magnetic footprint” on the territory (defined hereinafter as First Approximation Distance, DpA, which, in particular, refers to the magnetic field isovalue curve of 3 microteslas projected on the ground).

In this respect, it may be useful to think that a 220 kV single-circuit overhead power line with an aluminium-steel conductor (diameter 31.5 mm) for an amperometric capacity of 710 A is associated with a DpA of approximately 46 metres in total, and if a high-temperature conductor (diameter 31.25 mm) with an amperometric capacity of 1264 A were used, the corresponding DpA would increase to approximately 60 metres in total.

One solution adopted to date to reduce the magnetic field and the electric field produced by the power line at a potential receptor has been to replace the pylons of the original single-circuit line with new double-circuit poles, i.e., in electrical terms, a single circuit doubled in the number of conductors and optimised through the adoption of a particular electrical sequence of the corresponding electric phases: the so-called anti-symmetric phase arrangement. Although this solution succeeds in achieving a 50% reduction in the magnetic field generated on the line axis, it, however, results in a significant increase in visual interaction, for example due to the greater height of the double-circuit pole compared to the single-circuit pole, and in any case, still in terms of magnetic field reduction, it may not be sufficient if the receptor is very close to the line axis, where the magnetic field is significantly higher.

There was, therefore, a strong need for a technical solution capable of constructing overhead power lines, in particular medium- and high-voltage power lines, that could guarantee either a reduction of the magnetic field on the receptors present, with the same electric current, or a containment of the same magnetic field on the receptors, even in the presence of transmitted electric currents significantly higher than those of the prior art.

In addition, the solution also has the peculiarity of guaranteeing a significant limitation of the electric field value, especially in the so-called band of interest of the power line and compared to known solutions. Such a peculiarity is particularly perceived in Extra High Voltage lines when any possible legal constraints on the limit of exposure to the electric field could substantially limit operation thereof.

The inventors of the present invention have conceived new types of pylon for overhead power lines, in particular for medium and high voltage, capable of satisfying the above-mentioned need while ensuring high environmental and social sustainability, guaranteeing a rapid authorisability of the works, improved safety of system electrical operation, confirmed resilience of the structures and, finally, immediate integration with existing power lines. These and further advantages will be reported in detail in the following description.

### OBJECT AND SUMMARY OF THE INVENTION

The present invention relates to an overhead power line, in particular for medium and high voltage, comprising a five-phase power line, wherein there are five electrical phases (for a given number of conductors) and a plurality of pylons, including five-phase pylons, each including a head portion to which the five electrical phases are fixed by means of respective five attachment points, and a ground support portion fixed to said head portion; said five attachment points comprising four external attachment points arranged at the vertices of a quadrilateral and vertically misaligned with each other, and an internal attachment point arranged within said quadrilateral and vertically misaligned with said external attachment points. Preferably, each of the attachment points is of the suspension type supported by a pair of insulator chains arranged in a “V” or “L” shape and fixed to said head portion.

In the present document, position indications such as “vertical”, “horizontal”, “above” and “below” relate to the operating position of the pylons as shown in the attached figures.

Preferably, the power line comprises a transition pylon for converting an existing three-phase line, on one side, to a five-phase line, on the other side; said transition pylon comprising a head portion and a ground support portion fixed to said head portion; the five electrical phases being fixed to said transition pylon by respective five attachment points; said five attachment points being of the strain type and comprising four external attachment points arranged at the vertices of a quadrilateral and vertically misaligned with each other, and an internal attachment point arranged within said quadrilateral and vertically misaligned with said external attachment points; each pair of external attachment points positioned at opposite vertices of said quadrilateral corresponds to the duplication of the respective corresponding phase of the existing three-phase line; said internal attachment point corresponds to the remaining electrical phase of the existing three-phase line.

Preferably, said head portion is connected to two guard cables.

Preferably, said head portion is defined by a horizontal structure and two vertical structures intersecting said horizontal structure; said internal attachment point being connected to said horizontal structure between the two vertical structures.

Preferably, each of said pairs of insulator chains arranged in a “V” shape is connected to a bracket extending horizontally from one of said vertical structures of the head portion.

Preferably, the pair of insulator chains arranged in an “L” shape and adapted to support the internal attachment point comprise an insulator chain fixed to the horizontal structure and an insulator chain fixed to one of the vertical structures; each of the two pairs of insulator chains arranged in an “L” shape adapted to support two respective external attachment points of a first side part of the pylon comprise an insulator chain fixed to a bracket extending horizontally from one of said vertical structures and an insulator chain fixed to the same vertical structure; the insulator chains of each of the two pairs of “L” shaped insulator chains adapted to support two respective external attachment points of a second side part of the pylon are fixed to an “inverted L”-shaped bracket extending horizontally from one of said vertical structures.

Preferably, said quadrilateral is an inverted isosceles trapezoid and said internal attachment point is horizontally misaligned with said external attachment points.

Another object of the present invention is a method for reducing the magnetic field generated by an overhead power line, in particular for an overhead medium- and high-voltage power line; said method being characterised by including a transition pylon adapted to convert a three-phase line into a five-phase line and a plurality of five-phase pylons; said transition pylon and said five-phase pylons being adapted to support five electrical phases by means of five respective attachment points; said five attachment points comprising four external attachment points arranged at the vertices of a quadrilateral and vertically misaligned with each other, and an internal attachment point arranged within said quadrilateral and vertically misaligned with said external coupling points; each pair of external attachment points, positioned at the opposite vertices of said quadrilateral, corresponds to the duplication of the respective corresponding phase of the existing three-phase line; said internal attachment point corresponds to the remaining electrical phase of the existing three-phase line.

Preferably, each of the attachment points of the five-phase pylons is of the suspension type and is supported by a pair of insulator chains arranged in a “V” or “L” shape.

For a better understanding of the present invention, particular embodiments are hereinafter described for illustrative and non-limiting purposes with the aid of the accompanying figures, wherein:

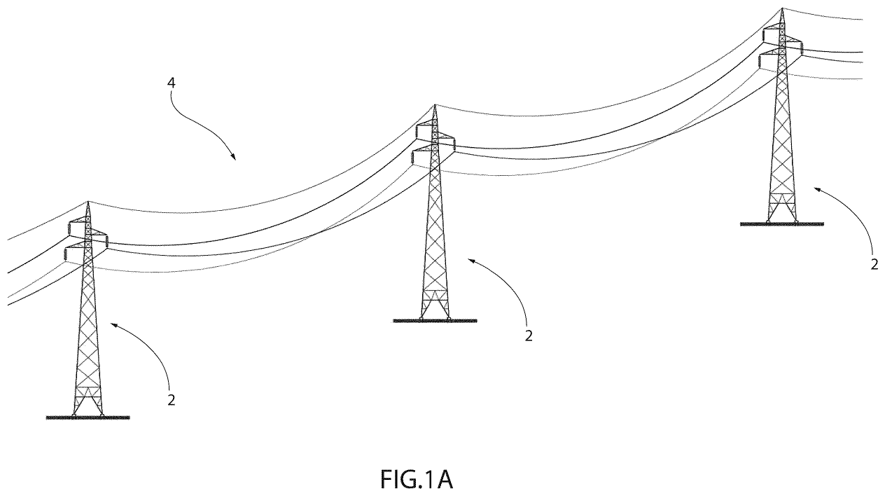

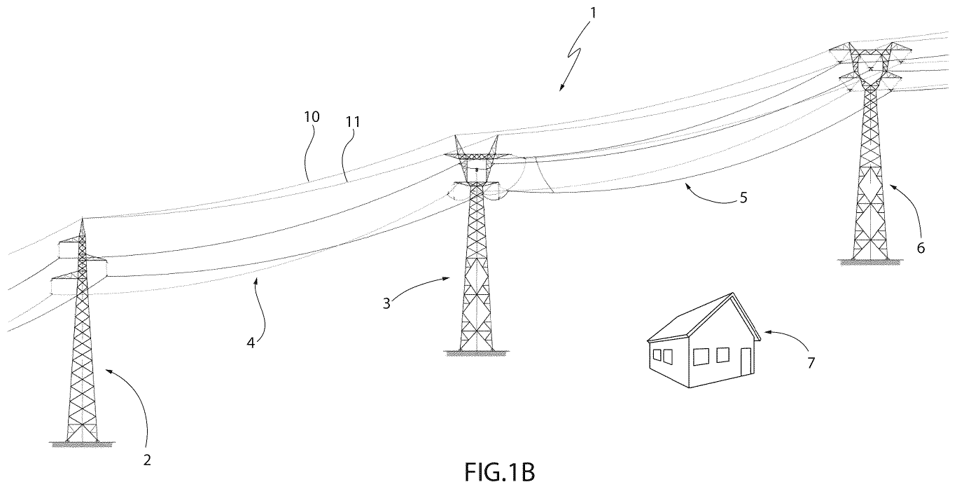

FIG. 1A schematically shows a portion of an overhead power line, particularly for medium and high voltage, according to an embodiment of the prior art;

FIG. 1B schematically shows a portion of an overhead power line, particularly for medium and high voltage, according to the present invention where, by means of the peculiar new pylons which are the subject of the invention, the power line is easily integrated into the existing power line according to the prior art;

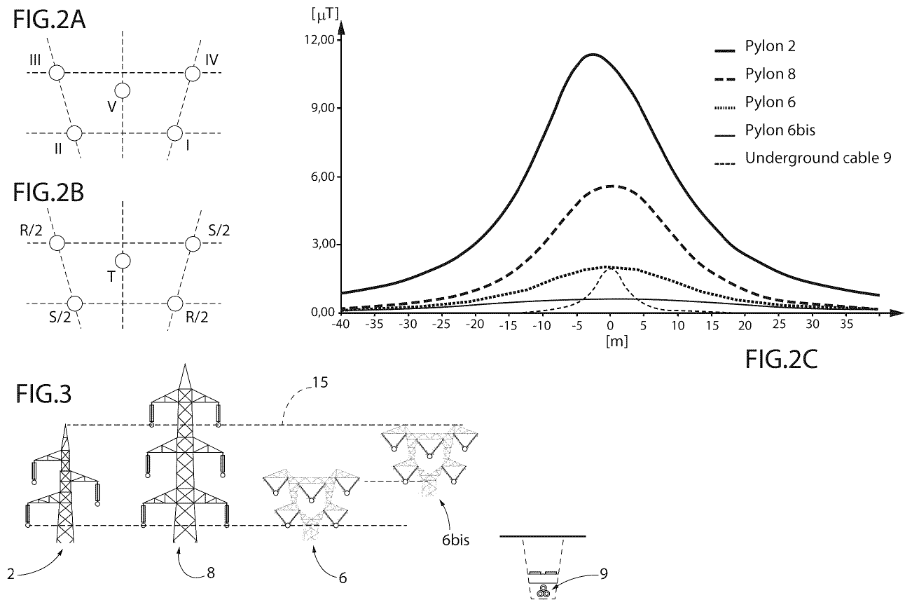

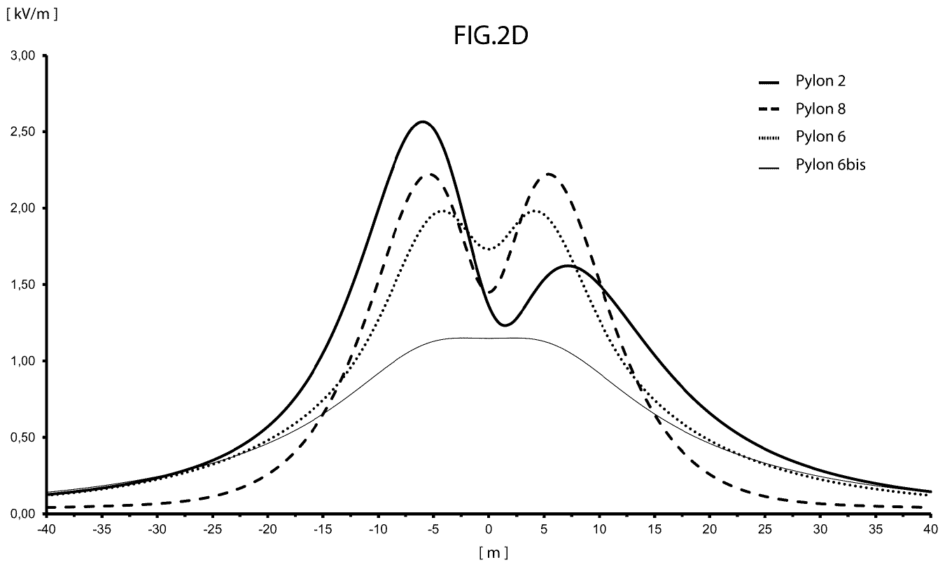

FIGS. 2A and 2B are two representations of the geometry of the five attachment points of the electrical phases in the pylons of the power line object of the invention;

FIG. 2C is a comparative graphical representation of the magnetic field curves (magnetic induction) with respect to the overhead power line that can be realised with the types of pylons of the present invention and the overhead and cable power lines of the prior art;

FIG. 2D is a comparative graphical representation of the electric field curves regarding the overhead power line that can be realised with the types of pylons of the present invention;

FIG. 3 shows the comparison of known types of pylons with those of the present invention, as well as with the underground cable solution;

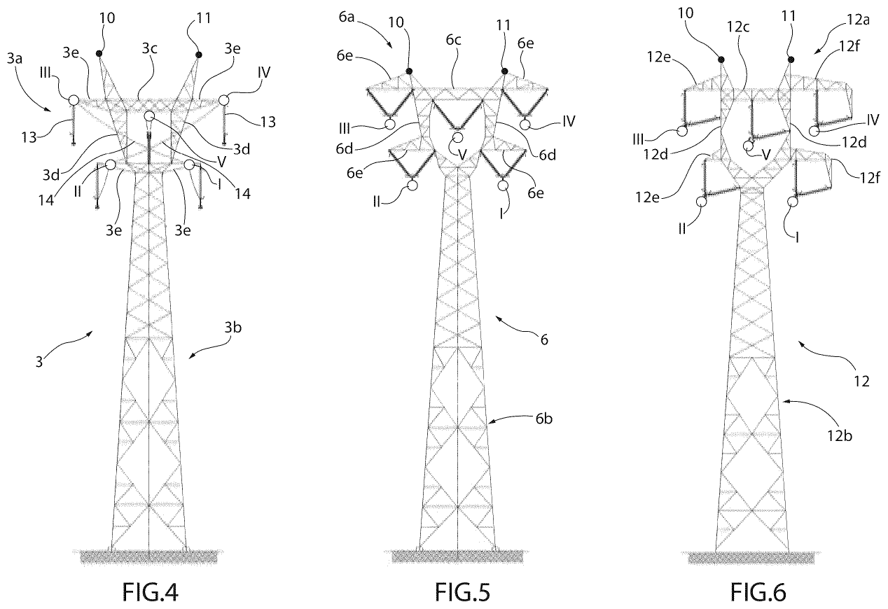

FIGS. 4, 5 and 6 show three respective types of pylon according to the present invention;

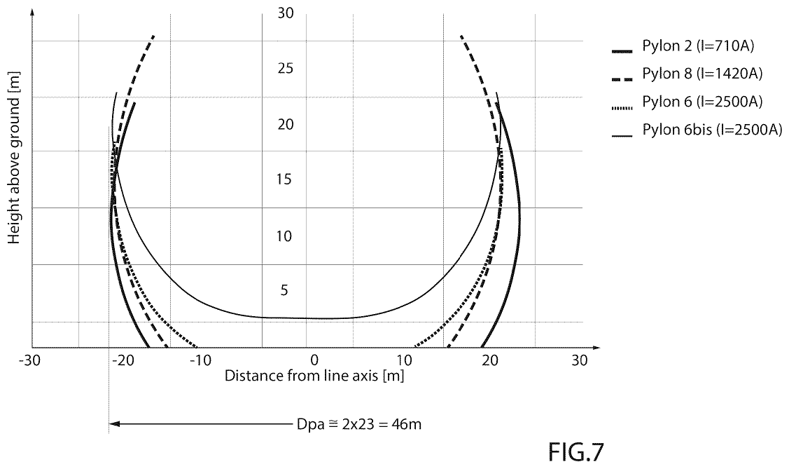

FIG. 7 is a comparative graphic representation, with the same territory occupation (Dpa), of the magnetic field (magnetic induction) isovalue curves, referred to 3 microteslas, produced by different electric currents in relation to the pylons of the present invention and those of the prior art;

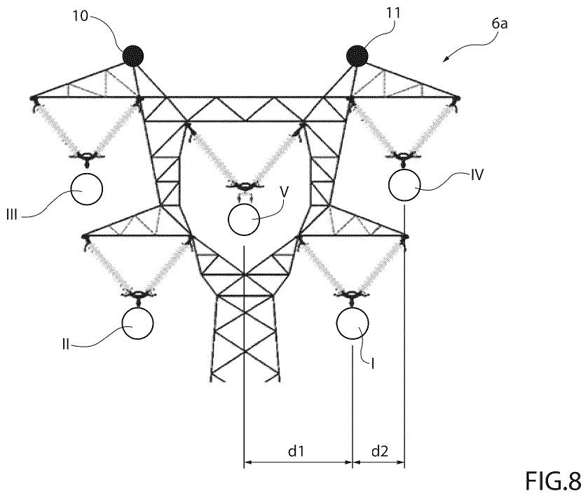

FIG. 8 shows a head portion of one of the pylons of the present invention, wherein the vertical offset of the electrical phases is represented;

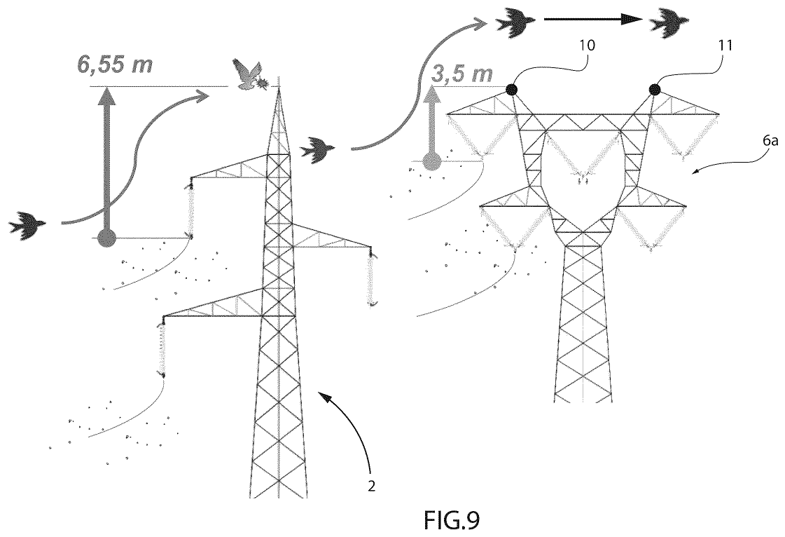

FIGS. 9, 10 and 11 show a comparison between a pylon of the invention and a pylon of the prior art with regard to respective aspects of environmental sustainability;

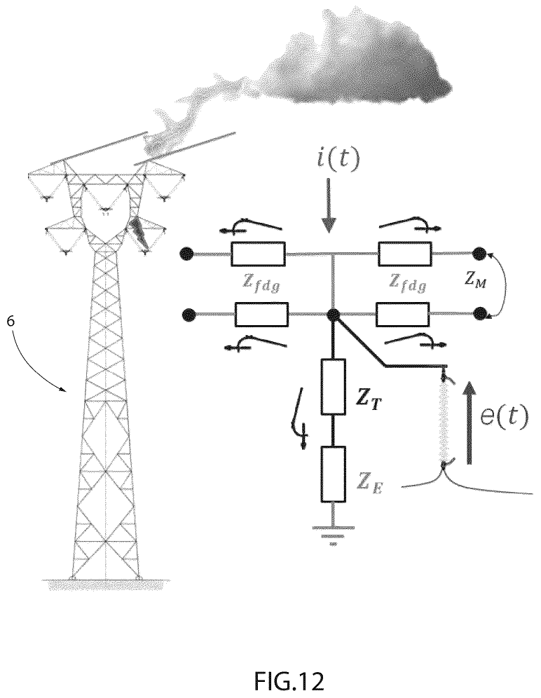

FIG. 12 shows the improved coverage of the conductors of the invention in terms of reduced risk of direct lightning strikes;

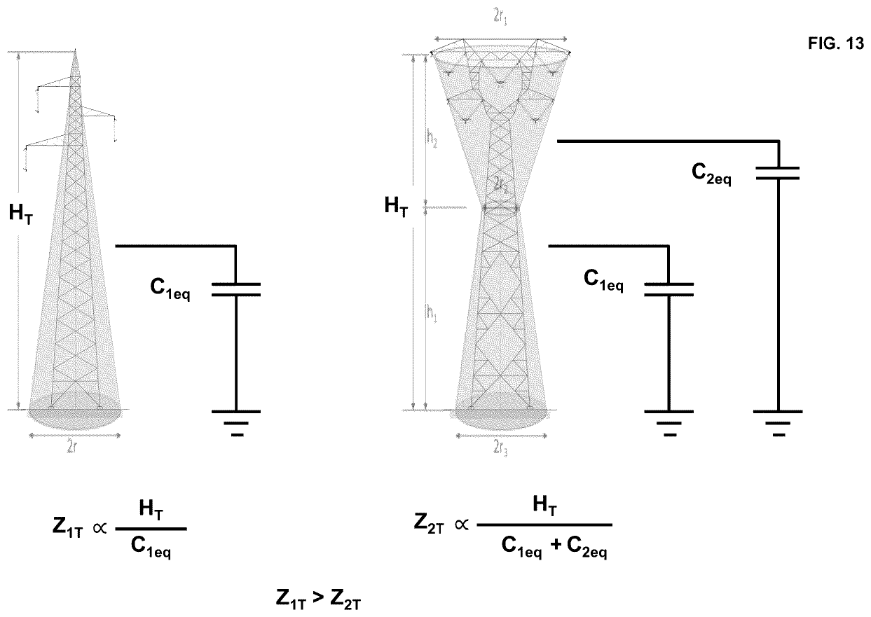

FIG. 13 shows, by virtue of the geometric features of the invention, the particularity of obtaining an impedance of the pylon of the invention lower than the prior art.

In FIG. 1A, an overhead single-circuit power line according to the prior art, of the type comprising a plurality of pylons 2, of the single-circuit type, is globally referred to as 4.

In FIG. 1B a section of an overhead power line according to the present invention is globally referred to as 1. The power line 1 comprises a pylon 2 of the single-circuit type (prior art), followed by an anchor pylon, in this case with the function of a transition pole 3, for converting a three-phase line 4 into a five-phase line 5, and a suspension pylon that gives continuity to the five-phase line, i.e. a pylon with insulator chains arranged in a “V” shape and referred to as 6.

Thereby, the invention enables the transition from a three-phase line 4 to a five-phase line 5 and vice versa, i.e. to return from a five-phase line 5 to a three-phase line 4, with the advantage of being able to obtain, for the same electric current, a significant reduction in the magnetic field on the present anthropized areas 7 or, for the same magnetic field, a significant increase in the electric current transmitted by the overhead line compared to those of the prior art.

In this description, the expression five-phase overhead line is used in accordance with the IEC 60050 dictionary (reference IEV 466-01-04), which states that the term phase, for an AC line, designates any conductor or bundle of conductors intended to be energised during normal use. Note that this definition is intended to distinguish single conductors, or bundles of closely spaced conductors, intended to be energised, from other conductors of an overhead line that are not intended to be energised, such as guard cables or compensation rings. However, there is no need for each phase of the line to be electrically out of phase with the other phases.

This is also made clear, in the same dictionary, in the definition of a polyphase or m-phase system, where it is specified that the phases are usually (but not necessarily) out of phase, and that phase differences can also be zero.

It should also be noted that, since each single phase can be defined by a single conductor or by several conductors forming a bundle (as in the case of twin or triple conductors), the total number of conductors is at least equal to the number of phases. Therefore, the five-phase line 5 includes five single conductors or bundles of conductors. Still in the dictionary concerned, it is specified (reference IEV 466-10-20) that a bundle of conductors is an assembly of individual conductors, connected in parallel and arranged in a uniform geometric configuration, that constitutes a phase or a pole of an overhead power line.

In FIG. 2A the geometry of the five attachment points of the relative electrical phases of the pylons according to the invention is shown. In particular, each of the pylons has four external attachment points I, II, III and IV arranged substantially at the vertices of an inverted isosceles trapezoid and an internal attachment point V arranged within the trapezoid in a vertically and horizontally misaligned position with respect to the other attachment points I, II, III and IV. Therefore, the external attachment points I, II, III and IV are horizontally aligned two by two.

Note that the arrangement of the attachment points I, II, III, IV and V is symmetrical with respect to a vertical axis.

FIG. 2B shows, from an electrical perspective, the arrangement of the so-called five electrical phases, corresponding in any case to a three-phase system (only here meaning that a periodic alternating electrical quantity, such as voltage or current, assumes, in different conductors or bundles of conductors in the system, time shapes with a total of three mutual predetermined phase shifts), according to the invention. In particular:
The attachment points of conductors I, III correspond to the duplication of the electrical phase R of the three-phase connection,
The attachment points of conductors II, IV correspond to the duplication of the electrical phase S,
The attachment point of conductor V corresponds to the electrical phase T.

Therefore, electrical magnitudes such as voltage or current relating to conductors or bundles of conductors at opposite vertices of the quadrilateral have essentially a zero phase shift between them.

In FIG. 2C the magnetic field curves (magnetic induction) generated by the geometric configurations of the pylons of the prior art are compared with those of the pylons of the present invention, for example for a 220 kV power line and for the same electrical current of the connection (710 A), as well as with that of an underground cable power line. In particular, FIG. 3 shows in detail the single-circuit pylon 2 already shown in FIG. 1A, a double-circuit pylon 8 (having the same working height, i.e. the height with respect to the ground, of the lowest conductor, at the attachment to the pylon), the five-phase pylon 6 according to the invention and already shown in FIG. 1B (having the same working height as the previous ones), as well as a further pylon 6bis, also in five phases according to the invention and named Skyline. The Skyline pylon 6bis differs from the pylon 6 in terms of height, since the corresponding power line that can be constructed with said type of pylon remains within the visual occupation limits 15 of the horizon outlined by the original guard cable.

As is clearly shown in the diagram in FIG. 2C, the geometry of the five conductor attachment points of the pylons, according to the present invention, allows to significantly reduce the magnetic field. In fact, the graph shows how the pylon 6 achieves an on-axis reduction in the magnetic field of about 80% if compared to the single-circuit pylon 2, and about 60% if compared to the double-circuit pylon 8. In particular, the magnetic field produced by the pylon 6 according to the invention is even comparable to that generated by an equivalent underground cable line 9.

Similarly, in the graph of FIG. 2D related to the electric field trend, it can be observed that the geometry of the five attachment points of the conductors of pylon 6 also allows to reduce the electric field peak values, both compared to the traditional solution of pylon 2, in single-circuit, and compared to the solution of the pylon 8, in double-circuit, which is particularly useful in case of Very-High-Voltage lines, where it is necessary to fall below a certain electric field exposure limit-value.

As can be immediately clear from the representation of the pylons in FIG. 3, the pylon 6 also has the advantage of ensuring a visual impact on the territory, if only in terms of the total height of the structures, which is significantly lower than that of pylons 2 and 8 of the prior art.

Moreover, if the pylon 6 were to be brought within the visual occupation limits 15 of the horizon outlined by the original guard cable of the prior art single-circuit pylon 2, the Skyline-type configuration (pylon 6bis) would be obtained, with the consequent advantage (shown in FIG. 2C) of an even lower magnetic field as perceived by the receptors, constantly below the value of 3 microteslas, indicated by the regulation as a quality objective, and substantially comparable to, if not lower than, the magnetic field (magnetic induction) produced by the underground cable line 9.

Similarly, for the electric field in FIG. 2D, the Skyline-type configuration, i.e. pylon 6bis, highlights once more the “flattening” effect that the solution brings to the distribution curve of the electric field produced.

If, rather than thinking using an approach intended to reduce the magnetic field, we were to reflect in terms of a magnetic footprint over the territory (DpA) being equal between the original backbone and the new innovative backbone, as shown in FIG. 7, with the five-phase overhead power line according to the invention, it is possible to significantly increase the total electric current transmitted by the power line (in this case, going from 710 to 2500 amperes is even three times greater than the electric current of the original single-circuit power line).

Moreover, although transmitting a much higher electrical current, the five-phase pylon power line produces an overall DpA even lower than that of a single-circuit or double-circuit line, according to the prior art.

Furthermore, considering the Skyline type five-phase pylon 6bis, in addition to the advantage of being able to increase the electric current and thus the electric power transmitted, there is also the advantage of having an isovalue curve of magnetic induction at 3 microteslas placed at a height of more than 2.5 metres above the ground even below the vertical of the power line, with unique and obvious advantages in terms of availability of the territory.

In FIG. 4 the anchor pole 3 is shown where the particular geometry of the attachment points can be noted, as already shown in FIGS. 1B, 2A and 2B.

In greater detail, the pole 3 is of the transition type and comprises a head portion 3a and a ground support portion 3b. The head portion 3a is substantially defined by a horizontal structure 3c and two vertical structures 3d intersecting the horizontal structure 3c. In the head portion 3a, the attachment points I, II, III, IV and V are formed. In particular, the external attachment points I, II, III and IV are formed on respective brackets 3e that extend horizontally from the head portion 3a, more specifically from the two vertical structures 3d.

Thus, when the pole serves as a transition pylon 3, the attachment points of conductors I, III correspond to the duplication of the electrical phase R of the three-phase connection, while the attachment points of conductors II, IV correspond to the duplication of the electrical phase S.

Finally, the internal attachment point of conductor V is fixed to the horizontal structure 3c and corresponds to the electrical phase T.

The transition pylon 3 substantially receives a three-phase electrical line 4 and converts it to a five-phase electrical line 5 (and vice versa) by duplicating two of the three electrical phases. In particular, as shown in FIG. 1B, two conductors of the three-phase electrical line 4 engage the lower attachment points I and II and, by means of diagonal electrical connections 14, downstream of the pylon, the two respective phases are duplicated with conductors from the upper attachment points III and IV.

When, on the other hand, the pole 3 serves as an anchor pole, to be used on the five-phase power line sections of the invention and for paths with significant angularity, the complete use of the attachment points I, II, III, IV and V is envisaged both at the arrival and departure of the line; in particular, for the attachment points III and IV the use of the insulator chains 13 (to guarantee the electrical safety towards the structure of the pylon 3) is foreseen for the recall of the dead necks, which are necessary for the continuity of the high electrical phases R/2 and S/2 shown in FIG. 2B. In this configuration, the diagonal electrical connections 14 for duplicating the electrical phases have not been implemented.

It is worth emphasizing that the anchor pylon 3, with or without the function of switching a three-phase line 4 into a five-phase line 5, is always considered an example of a five-phase pylon.

For both of the two possible configurations described above, the ends of the two vertical structures 3d, arranged above the horizontal structure 3c, define two attachment points for two respective guard cables 10 and 11.

In FIG. 5 the five-phase pylon 6 is shown as having the same geometry as seen above (FIGS. 1B, 2A and 2B) and characterised by the presence of insulator chains arranged in a “V” shape.

The five-phase pylon 6 is, in particular, of the suspension type and comprises a head portion 6a and a ground support portion 6b. The head portion 6a is substantially defined by a horizontal structure 6c and two vertical structures 6d intersecting the upper horizontal structure 6c. From each of the two vertical structures 6d, four brackets 6e extend, to which “V”-shaped insulator chains supporting the external attachment points I, II, III and IV are fixed, which are, in turn, all below the horizontal structure 6c. The “V”-shaped insulator chains supporting the internal attachment point V are fixed to the upper horizontal structure 6c and are arranged between the two vertical structures 6d.

In addition, the upper ends of the two vertical structures 6d, arranged above the horizontal structure 6c, define two attachment points for two respective guard cables 10 and 11.

Substantially, the five-phase pylon 6 is a suspension pylon which, through the use of “V”-shaped insulator chains and compact conductor geometry, makes it possible to achieve (a) a reduced relative distance between the electrical phases; (b) a high longitudinal mechanical stability of the catenaries; (c) a high resilience to wind action.

In FIG. 6 a further type of five-phase electrical pylon 12 having the same geometry as seen above (FIGS. 2A and 2B) and in which the attachment points are provided with two insulator chains substantially arranged in an “L” shape is shown.

The five-phase pylon 12 is of the suspension type and comprises a head portion 12a and a ground support portion 12b. The head portion 12a is substantially defined by a horizontal structure 12c and two vertical structures 12d intersecting the upper horizontal structure 12c. Two brackets 12e extend horizontally from a first one of the two vertical structures 12d. One of the insulator chains is fixed to each of the brackets 12e while the other insulator chain of the same “L”-shaped pair is fixed to the vertical structure 12d. The pair of insulator chains will thereby have an “L”-shaped arrangement to support the attachment points II and III. Two brackets 12f consisting of two portions arranged at right angles to each other (globally forming an inverted “L”) and to each of which an insulator chain of the same pair is fixed extend horizontally from a second of the two vertical structures 12d. The pair of insulator chains will thereby have an “L”-shaped arrangement to support the attachment points I and IV.

The “L”-shaped insulator chains supporting the internal attachment point V are fixed to the horizontal structure 12c and one of the two vertical structures 12d, respectively.

In the five-phase pylon 12 all the attachment points I, II, III, IV and V are below the horizontal structure 12c.

In addition, the upper ends of the two vertical structures 12d, arranged above the horizontal structure 12c, define two attachment points for two respective guard cables 10 and 11.

The five-phase pylon 12 using “L”-shaped chains is especially developed to allow the line to make angles of up to 30°, maintaining the suspension solution without, therefore, having to resort to an anchor pylon.

The type of pylon 12, in addition to providing the advantages mentioned above in relation to the pylon 6, makes it possible to handle line angles of up to 30° with a suspension solution instead of an anchor solution, which is much more resilient in case of longitudinal load imbalances on the conductor.

Each of the pylons 3, 6 and 12, providing the geometry shown in FIGS. 2A and 2B, ensures the vertical offset of the electrical phases and thus maintains excellent ice-snow resilience characteristics with regard to the formation and detachment of the sleeves. In fact, in the event of snow and/or ice forming on the conductors, the relative lowering thereof does not represent a critical element, in terms of reducing the electrical safety between the strings and, consequently, allows the correct continuity of operation of the HV backbone. In this regard, it is important to emphasise that the geometry of the inverted trapezoid conductors is especially designed so that the distances d1 and d2, as reported in FIG. 8, are greater than or equal to the minimum distances dictated by the good art, depending on the nominal voltage value of the line.

In addition to the above advantages, the pylons of the present invention also provide greater protection in terms of direct lightning strikes. In fact, the geometric arrangement of the guard cables 10 and 11 provides a much more effective shielding than the single- and double-circuit pylons of the prior art. In fact, the presence of two guard cables per pylon and the special geometry of the pylon itself ensure significantly lower shielding angles than those of the pylons 2 and 8, i.e. significantly lower than 30°, thus reducing the likelihood of a direct lightning strike failure of the conductors.

Furthermore, the pylons 3, 6 and 12 of the present invention, if compared to pylons 2 and 8 of the prior art make it possible to reduce the reverse discharge failure rate thanks to two advantages:
(i) Greater number of guard cables and therefore lower equivalent wave impedance thereof (by having twice as many guard cables, the equivalent wave impedance of the guard cables is halved compared to a single- or double-circuit pylon, as shown in FIG. 12;
(ii) Lower wave impedance of the pylon itself thanks to its particular geometry, which can be approximated (see FIG. 13) to two cones (referring respectively to the Delta head and the stem) providing a higher total electrical capacity to the ground (i.e. the sum of the capacitances referring to the Delta head and the stem), quantifiable in the order of about 15%. This aspect reduces, for the same electrical current drained to earth by the pylon, the reverse discharge voltage on the insulator chains.

In the first moments after the lightning strikes on the pylon (FIG. 12), the combined effect of the reduction of the wave impedance Z_{T} of the pylon and the reduction of the lightning current drained to earth, thanks to the doubling of the guard cables, makes it possible to reduce the reverse discharge over voltage e(t) by approximately 25%, with the same overall pole height H_{T} and lightning current IT impacting thereon.

These advantages make the pylon of the invention a very resilient solution in relation to extreme weather events, which are increasingly frequent due to global warming.

The above-mentioned use of a pole head such as the one of the described invention, provided with twice as many guard cables 10 and 11 as the traditional pylons 2 and 8, makes it further possible, in the event of a line failure, to significantly reduce the earth current and the corresponding contact and pitch voltages and, thus, to reduce the risk of electrocution. Such an advantage is particularly relevant with reference to the anthropized context where these pylons could be used by virtue of the aforementioned peculiarity of optimal magnetic field management.

A further advantage of the pylons of the present invention relates to the ability of transmitting electrical power over long distances where, due to the physical laws of matter, constraints dictated by the electrical parameters of the line occur, first and foremost the service electrical reactance, which identifies the degree of magnetic coupling between the power conductors. The service electrical reactance of an overhead power line is a function of the geometry of the pylon head, the sequence of electrical phases and the geometry of the conductor bundle.

It must be noted that, as a first approximation, the active electric power transmissible on an overhead power line is inversely proportional to the service electrical reactance and the length of the line itself, having a low service electrical reactance means that a high transmission power is made available. In this respect, the geometry of the five-phase pylon 3, 6, 12, together with the particular sequence of the electrical phases, makes it possible to significantly reduce the service electrical reactance, especially if compared to that of a conventional single-circuit overhead power line 2 and, in any case, lower by a further 5-7% than a conventional double-circuit solution 8 with symmetrical phases. Substantially, thanks to these characteristics, the pylons of the invention make it possible to more efficiently transport large powers over long backbones.

The pylons 3, 6, 12 of the invention, apart from involving the significant advantages reported above, also have advantages in terms of environmental and social sustainability.

In fact, if compared to the pylons 2, 8 of the prior art, the pylons of the invention have an improved structure from an environmental interaction perspective; in particular, when the electric power line crosses, for example, sites of community interest (SCI) or special protection areas (SPA) due to the presence of valuable bird life, it is necessary to reduce the potential risk of collision that may occur between the bird and the guard wire according to the known interaction mechanism depicted in FIG. 9. Birds sense the presence of the conductors, particularly due to the consequences of the corona effect (with the characteristic crackling on the surface of the conductors) and tend to raise their flight path to avoid the obstacle. By doing so, however, they could incur the potential risk of approaching the guard cable, which is not subject to the corona effect and which could be hardly visible at certain hours of the day (for example at dawn and dusk, in particular light conditions); well, the smaller relative distance between conductors and guard cables in the pylons of the invention 3, 6, 12, compared to the traditional ones 2 and 8, clearly reduces such a risk (see FIG. 9).

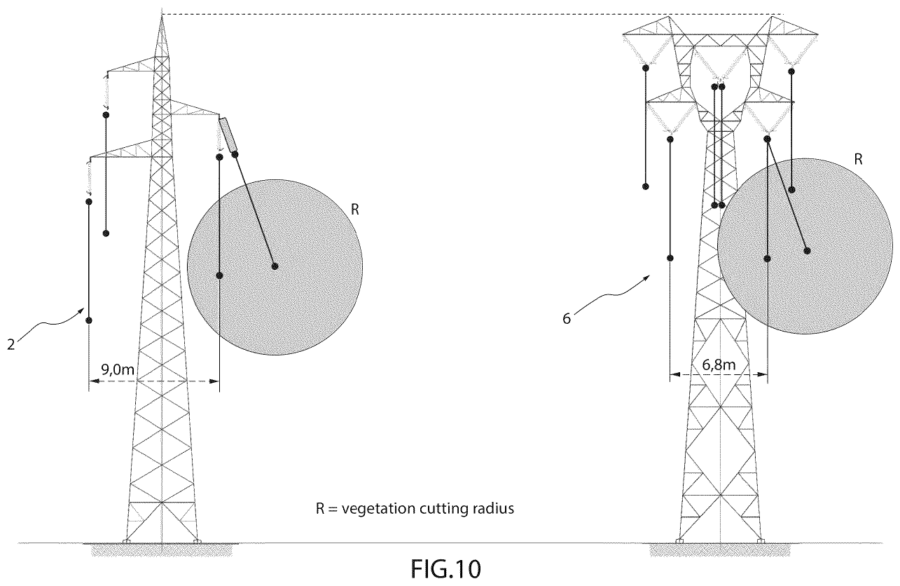

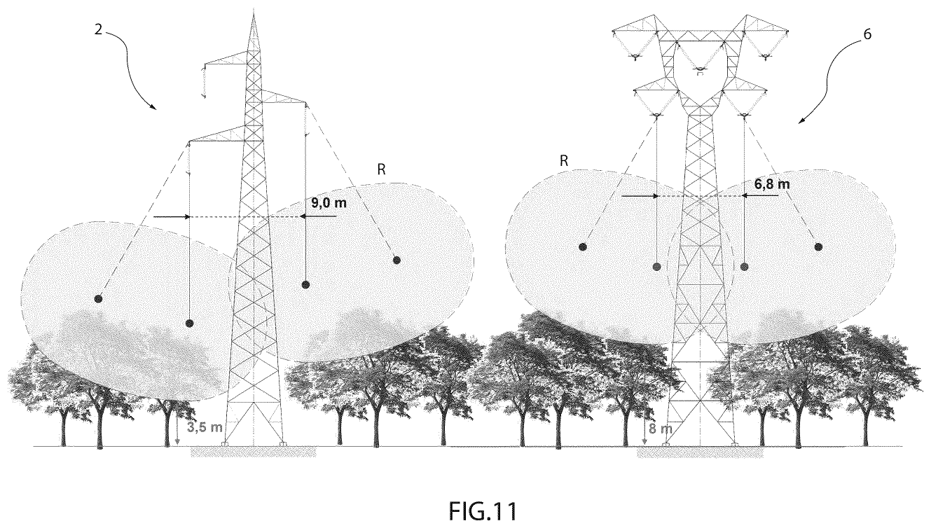

Another important advantage of environmental sustainability is shown in FIG. 10, where the pylon of the invention 6 is compared to the pylon of the prior art 2. It can be observed from FIG. 10 that the pylon of the invention has a smaller overall plan footprint of the low electrical phases (corresponding to the extremes of the smaller base of the inverted isosceles trapezoid and typical of the electrical phase geometry, FIGS. 2A and 2B, of the invention) as well as a shorter oscillation length of the catenary-insulator system, since the insulators of the pylon 6 of the invention are not involved in the oscillation of the catenary. All this, as depicted in FIG. 11, shows that the pylons of the invention interact less with the existing vegetation than the pylons of the prior art.

When it comes to social interaction, the new invention is also highly performing. In fact, given the many advantages listed so far, there is no increase in the characteristic interlocking band of the power line (which is known to be defined according to the projection of the conductors to earth and the oscillation of the catenary) and which, in this case, is lower by virtue of the advantages already listed, i.e. the containment of the outreach of the lower phases and the shorter oscillation length of the catenary-insulator system.

1. Overhead power line comprising a five-phase power line and a plurality of pylons, including a plurality of five-phase pylons each comprising:
a head portion to which the five electrical phases are fixed by means of five respective attachment points, and
a ground support portion fixed to said head portion;
said five attachment points comprising four external attachment points arranged at the vertices of a quadrilateral and vertically misaligned with each other and an internal attachment point arranged within said quadrilateral and vertically misaligned with said external attachment points;
said quadrilateral is an isosceles trapezoid with a larger base at the top and a smaller base at the bottom, and said internal attachment point is horizontally misaligned with said external attachment points.

2. Power line according to claim 1, wherein the external attachment points are formed on respective brackets extending horizontally from said head structure.

3. Power line according to claim 1, wherein the plurality of five-phase pylons comprises an anchor pylon; the five attachment points of the anchor pylon being of the strain type.

4. Power line according to claim 1, wherein the plurality of five-phase pylons comprises at least one transition pylon for converting a three-phase electrical line into a five-phase electrical line, and vice versa; two external attachment points of the conductors, preferably at vertices of the quadrilateral opposite to each other, corresponding to the duplication of a first electrical phase of the three-phase connection, preferably by means of a respective diagonal electrical connection, while two other external attachment points of the conductors, preferably at the vertices of the quadrilateral opposite to each other, corresponding to the duplication of a second electrical phase of the three-phase connection, preferably by means of a respective diagonal electrical connection; the internal attachment point of the conductor corresponds to a third electrical phase of the three-phase connection.

5. Power line according to claim 1, wherein each of the attachment points of at least one five-phase pylon is of the suspension type supported by a pair of insulator chains arranged in a “V” or “L” shape and fixed to said head portion.

6. Power line according to claim 1, wherein said external attachment points are horizontally aligned two by two.

7. Power line according to claim 1, wherein said head portion is connected to two guard cables.

8. Power line according to claim 1, wherein said head portion is defined by a horizontal structure and two vertical structures intersecting said horizontal structure; said internal attachment point being connected to said horizontal structure between the two vertical structures.

9. Power line according to claim 2, wherein said head portion is connected to two guard cables, and said brackets extend from the two vertical structures, in particular two brackets extend horizontally from a first one of the two vertical structures and two brackets extend horizontally from a second one of the two vertical structures.

10. Power line according to claim 2, wherein each of the attachment points of at least one five-phase pylon is of the suspension type supported by a pair of insulator chains arranged in a “V” or “L” shape and fixed to said head portion, and each of said pairs of insulator chains arranged in a “V” shape is connected to a bracket extending horizontally from one of said vertical structures of the head portion.

11. Power line according to claim 2 wherein each of the attachment points of at least one five-phase pylon is of the suspension type supported by a pair of insulator chains arranged in a “V” or “L” shape and fixed to said head portion, and the pair of insulator chains arranged in an “L” shape adapted to support the internal attachment point comprise an insulator chain fixed to the horizontal structure and an insulator chain fixed to one of the vertical structures; each of the two pairs of insulators chains arranged in an “L” shape to support two respective external attachment points of a first side part of the pylon comprise an insulator chain fixed to a respective bracket extending horizontally from one of said vertical structures and a chain of insulators fixed to the same vertical structure; the insulator chains of each of the two pairs of insulator chains arranged in an “L” shape adapted to support two respective external attachment points of a second side part of the pylon are fixed to a respective “inverted L”-shaped bracket extending horizontally from one of said vertical structures.

12. Method for reducing the magnetic field generated by an overhead medium- and high-voltage power line; said method comprising inserting a transition pylon for converting a three electrical phase line into a five electrical phase line and a plurality of five electrical phase suspension pylons; said transition pylon and said five electrical phase suspension pylons being capable of supporting the five electrical phases by means of five respective attachment points; said five attachment points V comprising four external attachment points arranged at the vertices of a quadrilateral and vertically misaligned with each other, and an internal attachment point arranged within said quadrilateral and vertically misaligned with said external attachment points, said quadrilateral being an isosceles trapezoid with a greater base at the top and a smaller base at the bottom, and said internal attachment point being horizontally misaligned with said external attachment points.

13. Method for reducing the peak values of the electric field generated by an overhead power line at extra high voltage; said method comprising inserting a transition pylon for converting a three-phase line into a five-phase line and a plurality of five-phase suspension pylons; said transition pylons and said five-phase suspension pylons being capable of supporting said five electrical phases by means of five respective attachment points; said five attachment points comprising four external attachment points arranged at the vertices of a quadrilateral and vertically misaligned with each other, and an internal attachment point arranged within said quadrilateral and vertically misaligned with said external attachment points, said quadrilateral being an isosceles trapezoid with a larger base at the top and a smaller base at the bottom, and said internal attachment point being horizontally misaligned with said external attachment points.

14. Method according to claim 12 wherein each of the attachment points of at least one five-phase electrical suspension pylon is supported by a pair of insulator chains arranged in a “V” or “L” shape.

15. Method according to claim 12, wherein the five attachment points of the transition pylon are of the strain type; two external attachment points corresponding to the duplication of a first electrical phase of the three-phase connection; two further external attachment points corresponding to the duplication of a second electrical phase of the three-phase connection; the internal attachment point corresponding to a third electrical phase of the three-phase connection.
